(19) United States
(12) Patent Application Publication
(10) Pub. No.: US 2009/0199789 A1
(43) Pub. Date: Aug. 13, 2009

(54) On demand, stored, positive pressurized air injection for internal combustion engines combustion chambers

(76) Inventor: Danny Franklin Beard, Cartersville, GA (US)

Correspondence Address: Danny Franklin Beard, 170 Oakleaf Drive S.W., Cartersville, GA, 30120, US

(21) Appl. No.: 12/069,163

(22) Filed: Feb. 8, 2008

(51) Int. Cl. F02B 63/06; F04B 41/04

(52) U.S. Cl. 123/2; 417/237; 123/198 F

(57) ABSTRACT

The idea that I am seeking to patent is the process of manufacturing and storing pressurized air to be injected into the combustion chamber of an internal combustion engine for ignition of the fuel. Unlike a standard engine, that continuously compresses air during every engine cycle, this engine will only compress the air that it needs for combustion or other functions. This compressive optimization saves the energy that would have been used to compress air continuously, thus significantly improving fuel economy. This requires the use of a storage facility. When the storage facility is pressurized to a predetermined amount this engine will no longer compress air. As the air is used and the storage facility pressure decreases to a predetermined amount, the compression cylinders valves may be aligned to raise the air pressure in the storage facility back up to the predetermined amount. This cycling of air to the storage facility for use as pressurized air injection on demand into the fuel firing cylinders is the basis of this invention. The engine will be comprised of a set of air compression cylinders and a set of fuel firing cylinders that can operate independent of each other. The engine valves will allow for compressing air without fuel firing, or fuel firing without compressing, or any combination thereof. Drawings are attached to illustrate some different configurations that can be accomplished with this arrangement. (These drawings are not intended to illustrate all the possibilities of this idea. They are offered as examples for understanding the basis of this invention).

### FIELD OF INVENTION

Internal Combustion Engines

### BACKGROUND OF INVENTION

The world has become overwhelmingly dependent on oil as a primary source to power moving and stationary internal combustion machines. This needs to change but it is not going to change immediately.

This invention is offered as an interim solution to this problem. Until we can develop other sources of fuel, this invention is capable of significantly increasing fuel efficiency of internal combustion engines, therefore, decreasing our dependency on oil or fossil fuels.

### SUMMARY OF INVENTION

I am seeking a patent on the following:
1) The use of stored positive pressurized air that can be injected on demand into the combustion chamber of new internal combustion engines.
2) The use of stored positive pressurized air that can be injected on demand into the combustion chamber of existing internal combustion engines (for the purpose of modification).
3) The use of stored positive pressurized air that can be injected on demand into the combustion chamber of mobile internal combustion engines.
4) The use of stored positive pressurized air that can be injected on demand into the combustion chamber of stationary internal combustion engines.
5) Incorporating as a function the engine the compressing of air to be injected into the internal combustion engine by means of delivery to a storage facility. The storage facility will maintain sufficient pressure and volume to supply air for combustion or other functions on demand.
6) The capability of timing the injection of pressurized air into the cylinders (independent of the engine strokes) to maximize combustion efficiency, horsepower, and fuel efficiency as a result.
7) The capability of controlling the pressure of the air injected into the cylinders (independent of the engine strokes) to maximize combustion efficiency, horsepower, and fuel efficiency as a result
8) The use of the momentum of a mobile vehicle to drive the compressing cylinders of a stored pressurized air injected internal combustion engine for regenerative energy when fuel is not being injected to fire the engine.
9) The use of the frame or chassis of a mobile vehicle as a storage facility for pressurized air to be used in the engine on demand.

### BRIEF DESCRIPTION OF DRAWINGS

FIG. 1 illustrates the general concept of how a multi cylinder engine could be built or modified for pressurized air injection. The number and configuration of the cylinders could vary. Also the displacement of cylinders within an individual engine could vary (Example: Compression cylinders could have more or less displacement than fuel firing cylinders depending on air pressure and volume requirements. Also, the number of cylinders could vary more or less based on horsepower needs).

FIG. 2 illustrates the two stroke compression cycle of a cylinder and the two stroke fuel firing cycle of a cylinder. Two stroke designs can be utilized since the compression and fuel firing cylinders can operate independently. But, this does not mean that there is a limit to the number of strokes that can be used.

FIG. 3 illustrates a general overview of how a pressurized air injection system could be incorporated into a chassis or frame. Of course, separate air tank storage would work well also.

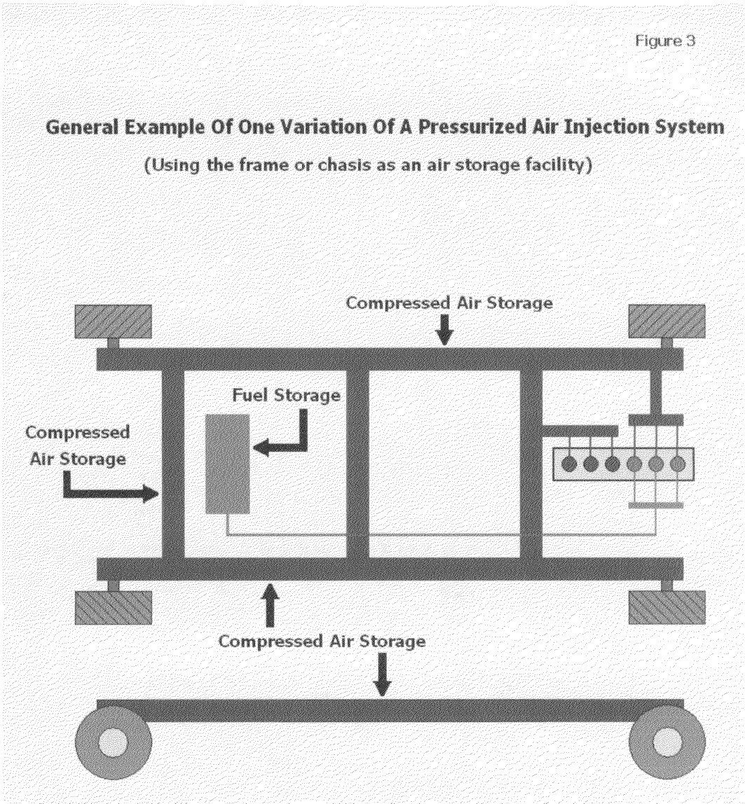

FIG. 4 (Engine Mode 1) illustrates how the engine compression and fuel firing cylinders valves can be aligned to allow the stored pressurized air to power a vehicle without using fuel. For illustration purposes, FIG. 4 shows only the fuel firing cylinders receiving air to drive the engine. Also, the compression cylinders could be aligned to drive the engine, or any combination of fuel firing and compression cylinders.

FIG. 5 (Engine Mode 2) illustrates how an engines compression cylinders could be aligned to rotate unloaded with no pressure build up when the air storage facility reaches it's required maximum pressure limit. Also, FIG. 5 (Engine Mode 2) illustrates how fuel can be introduced into the fuel firing cylinders to provide the power stroke while the compression cylinders are unloaded. (Of course, the fuel could be mixed with the pressurized air before injecting into the fuel firing chambers).

FIG. 6 (Engine Mode 3) illustrates how an engines compression cylinders could be aligned to build up pressure when the air storage facility reaches its required minimum pressure limit. Also, FIG. 6 (Engine Mode 3) illustrates how fuel can be introduced into the fuel firing cylinders to provide the power stroke while the compression cylinders are building pressure in the storage facility.

FIG. 7 (Engine Mode 4) illustrates how an engines compression cylinders could be aligned to build up pressure when the air storage facility reaches it's required minimum pressure limit with the fuel firing cylinders inactive (example of coasting downhill or when coming to a stop).

### DETAILED DESCRIPTION OF THE INVENTION

1. Description of how an on demand stored pressurized air injected internal combustion engine will work.

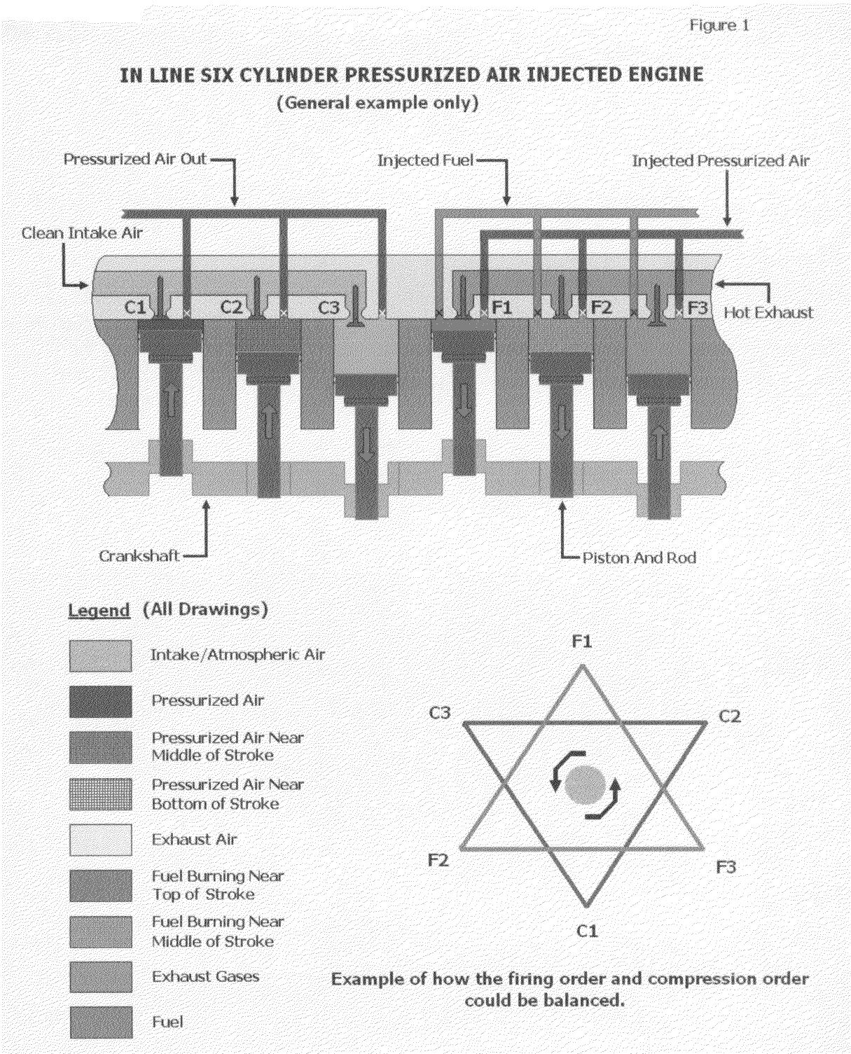

1) General Engine Description (FIG. 1)
For illustration purposes, this drawing is of an in line six cylinder pressurized air injection engine. The number or configuration of the cylinders could vary as needed. Also the cylinder sizes or strokes could vary as needed (Example: the Compression cylinders could have more displacement to supply more air).
C1, C2, and C3 cylinders are for compression of air only (there is no power stroke in these cylinders).
F1, F2, and F3 cylinders are for fuel firing or powering the engine only (there is no compression stroke in these cylinders).
All cylinders pistons are attached to a common crank shaft just like a standard engine but the valve timing can be uniquely designed to allow pressurized air to be sent to a storage facility and injected into the firing cylinders on demand.
With this arrangement, the pressure can be varied with a regulator and the timing of injecting the pressurized air can be varied for optimum efficiency (at a level never before achieved with a standard two stroke or four stroke internal combustion engine).

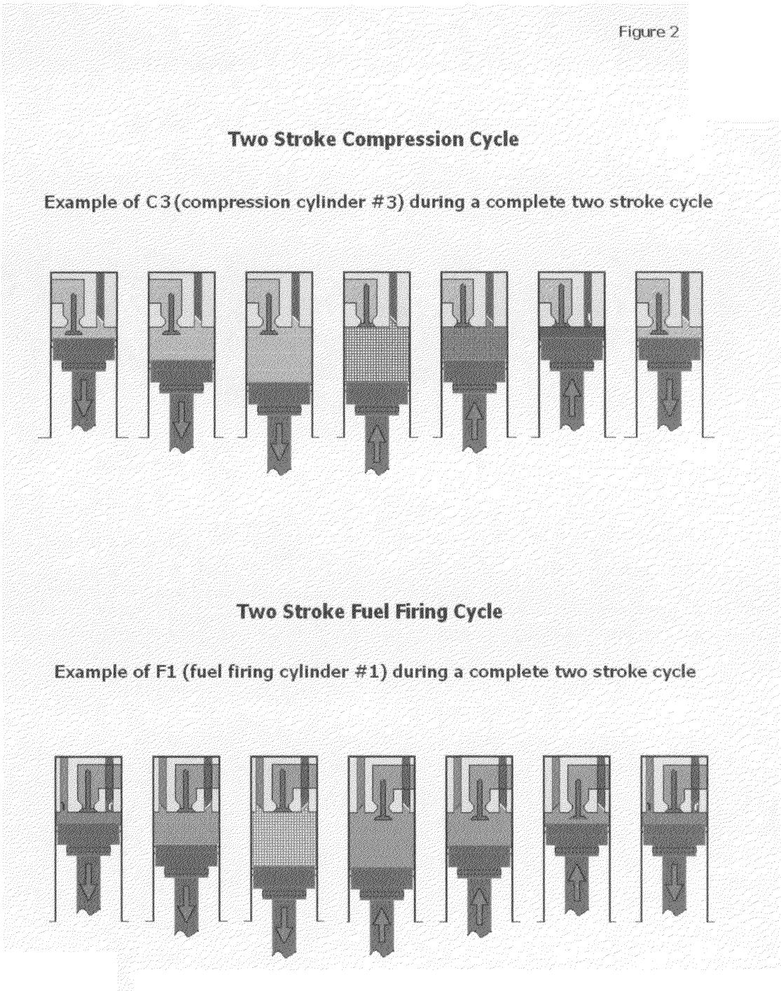

2) The Air Compression Cylinders Operation (FIG. 2)
With the intake valve open and the outlet valve closed, clean air is pulled into the compression chamber by the downstroke of the piston.
At the bottom of the downstroke the intake valve closes.
The air is compressed in the chamber by the upstroke of the piston.
At the top of the upstroke the outlet valve opens to divert the pressurized air to the storage facility.
As the piston begins another downstroke, the outlet valve closes to isolate the storage facility from the compression chamber.
At this point the inlet valve opens to allow air to be pulled into the compression chamber again by the downstroke of the piston.
Once the storage facility is fully pressurized, the outlet valve to the facility will close and the clean air intake valve will open. These valves will remain in these positions during the continuing strokes of the piston. These cylinders will continue to be unloaded until the storage facility needs additional pressure.
When the storage facility needs additional pressure, the valves will recycle as indicated above.
This compression two stroke cycling timing is independent of the power (or fuel firing) cycling.

3) The Fuel Firing Cylinders Operation (FIG. 2)
At the optimal point near the top of the piston upstroke the pressurized air inlet valve opens and fills the combustion chamber with compressed air. At this time the fuel valve also opens so fuel will mix with the air.
After fuel and pressurized air is injected into the combustion chamber both the fuel and air are shut off and a source of ignition can be introduced into the combustion chamber.
The expansion of this ignition forces the piston downward.
At the bottom of the downstroke the hot gas exhaust valve opens and the upstroke of the piston forces the waste gases out of the combustion chamber.
At the top of the upstroke this power cycling repeats as long as needed. When no longer needed the hot exhaust valves will remain open and the air/fuel inlets will remain closed. This fuel firing cylinder inactive condition will continue until fuel is needed to power the engine.
This fuel firing power cycling is independent of the compression cycling.

2. Description of how a moving vehicle may operate with an on demand stored pressurized air injection engine system installed.

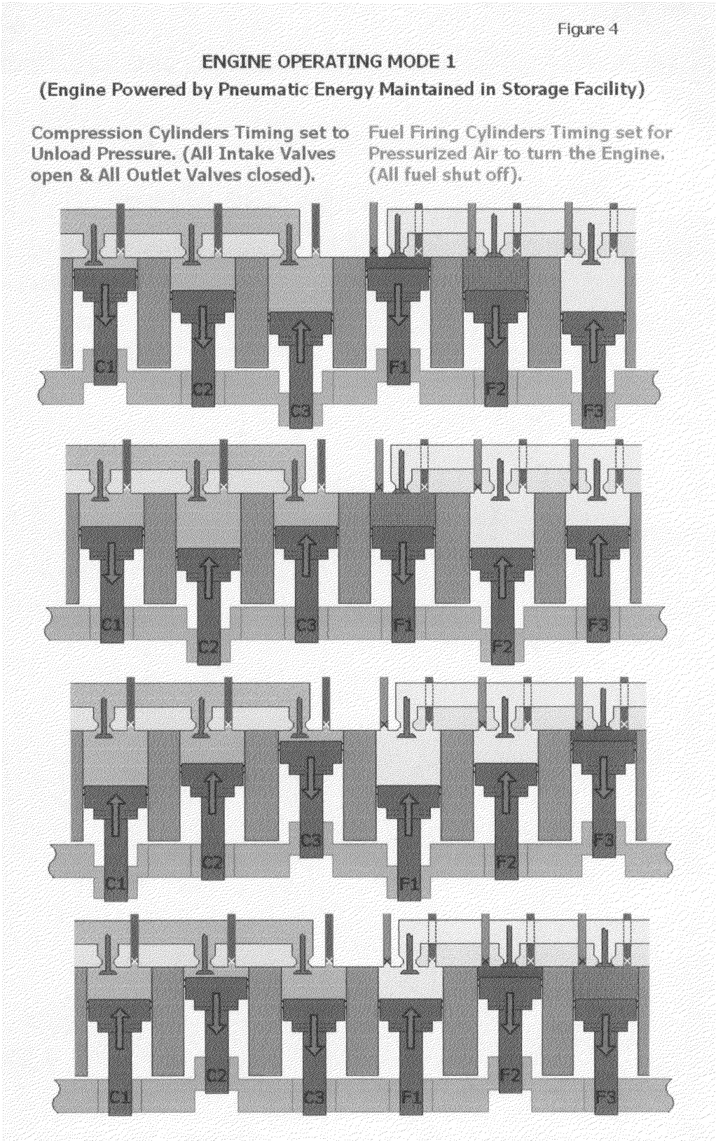

ENGINE MODE 1: From a still position and the storage facility pressurized
The compression cylinders are in the unloaded position and the fuel firing cylinders valves is aligned for air pressure to power the vehicle. (FIG. 4). (NOTE: This is for illustration only. The compression cylinders could also be aligned to power the vehicle or any combination of compression and fuel firing cylinders).
As the accelerator is pressed forward the vehicle will operate under pneumatic power without any fuel being used. No starter is required.

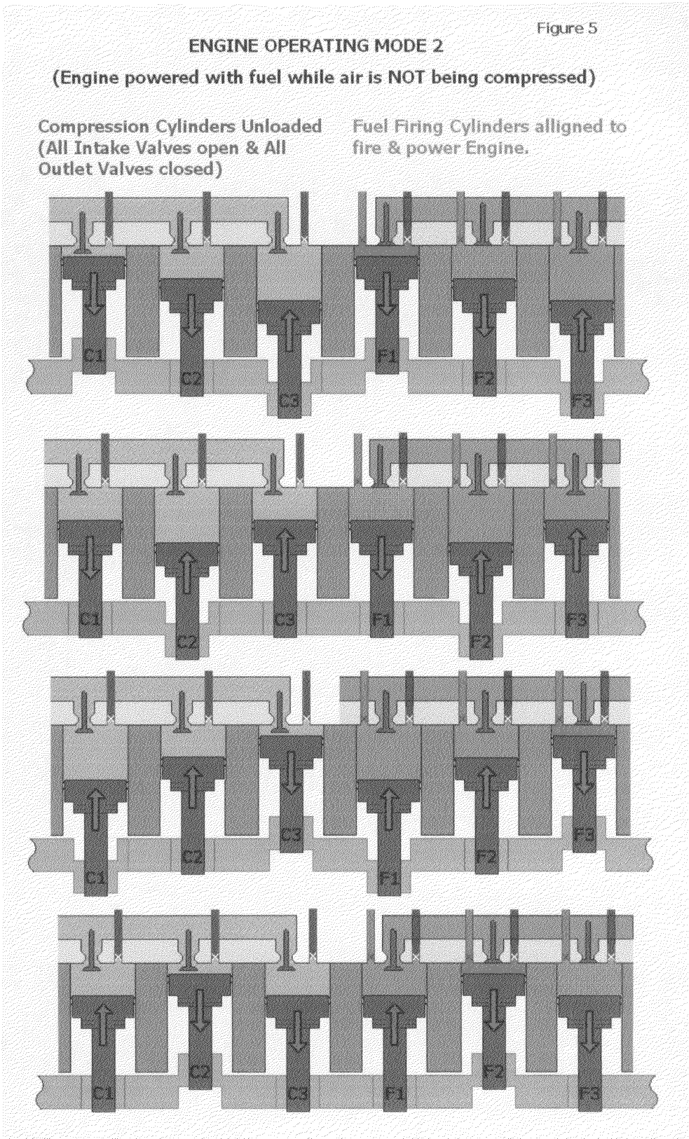

ENGINE MODE 2: Acceleration with C1, C2, and C3 Unloaded
As the speed of the vehicle increases and the stored air pressure decreases to a predetermined point, fuel will be introduced into the firing cylinders to provide power to continue the acceleration of the vehicle (FIG. 5).

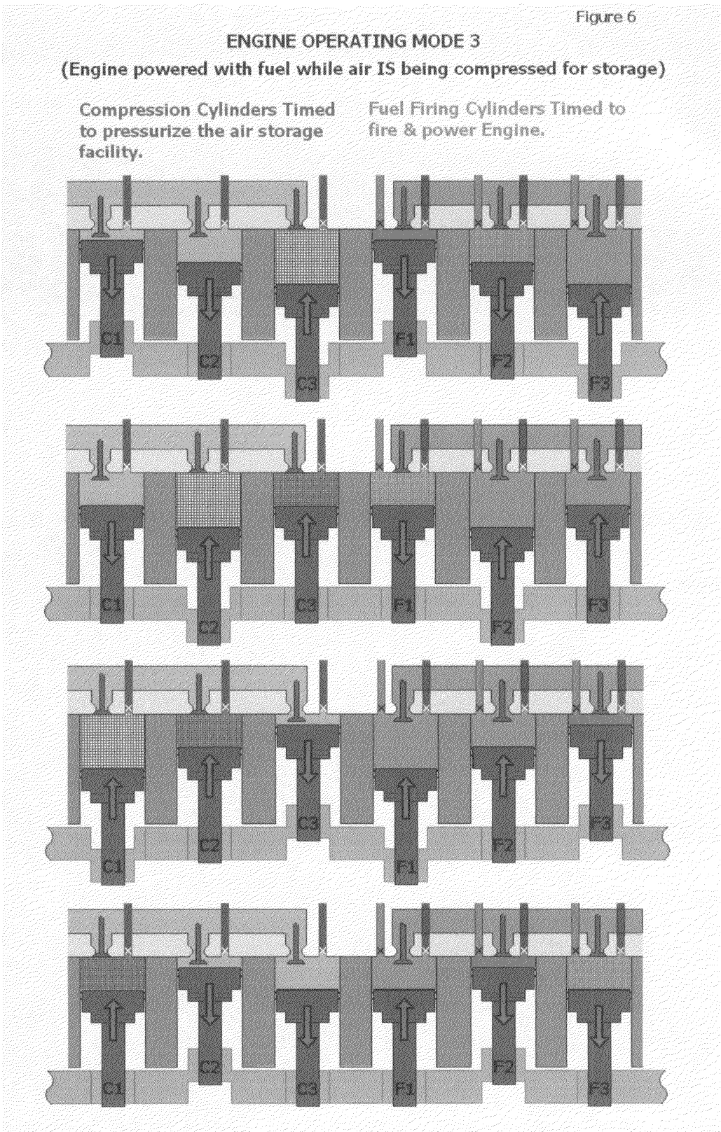

ENGINE MODE 3: Acceleration and maintaining speed
When the pressurized air storage facility decreases to a predetermined point, the compression cylinders valves will be aligned to replenish the air in the storage facility (FIG. 6). Also, as the firing cylinders continue to propel the vehicle, the engine will continue to cycle between Modes 2 and 3 (FIGS. 5 and 6) as long as acceleration or constant speed is desired.

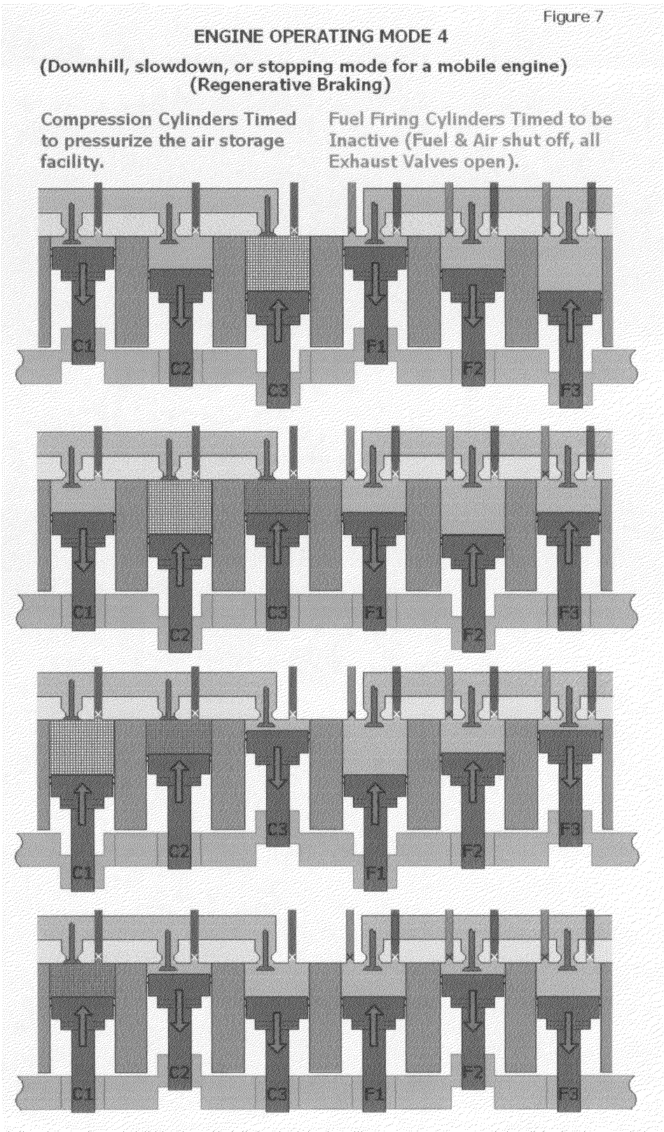

ENGINE MODE 4: Slowing down, coasting downhill, or stopping the vehicle.
When the vehicle needs to slow down, coast downhill, or stop; the engine will be capable of going into Mode 4 (FIG. 7). Whenever the accelerator is released, the fuel can be shut off. The compression cylinders can pressurize the storage facility if needed and the fuel firing cylinders can become inactive. (Of course a means would be required to transfer the momentum energy from the wheels to the engine in order to achieve this regenerative braking).

1. This engine design will allow the compression strokes and power strokes of an engine to be independent of each other. The air will be compressed only as is needed to perform a function (continuous compression with every cycle will not be required). This compressive optimization can significantly improve fuel efficiency of internal combustion engine designs and modifications.

2. This engine design will allow the fuel firing of the engine to be only as needed. Since pressurized air will be supplied from an independent storage facility, there will be no need to continuously introduce fuel in order to compress air.

3. This system will allow vehicles to be built now and in the future that will require less fuel than previous vehicles of similar weight that utilize standard internal combustion engines.

4. This system will allow standard internal combustion engines that have already been produced to be modified so as to utilize this pressurized air injection concept and decrease fuel consumption as a result.

5. The timing of the pressurized air injection can be controlled by a means independent of the engine strokes, therefore maximizing efficiency of fuel burn duration.

6. The pressure of the injected air can be controlled independently from the engine strokes, therefore maximizing efficiency of fuel to air ratio.

7. This system can be utilized on mobile internal combustion engines or stationary internal combustion engines.
